(19) United States
(12) Patent Application Publication
(10) Pub. No.: US 2015/0334254 A1
(43) Pub. Date: Nov. 19, 2015

(54) ELECTRIC EQUIPMENT

(71) Applicant: SHARP KABUSHIKI KAISHA, Osaka-shi, Osaka (JP)

(72) Inventor: Hiroki KINOSHITA, Osaka-shi (JP)

(21) Appl. No.: 14/651,402

(22) PCT Filed: Nov. 26, 2013
(86) PCT No.: PCT/JP2013/081725

§ 371 Date: Jun. 11, 2015

(30) Foreign Application Priority Data
Dec. 12, 2012 (JP) 2012-271362
Nov. 6, 2013 (JP) 2013-230567

(51) Int. Cl. H04N 1/00; G06F 3/0482; G06F 3/0484; G06F 3/0481

(52) U.S. Cl. CPC H04N 1/0097; G06F 3/04817; G06F 3/0482; G06F 3/04842; H04N 1/00474; H04N 1/00411; H04N 2201/0094

(57) ABSTRACT

Provided is an electric equipment capable of simply executing functions without examining an instruction manual whenever the same function is used, in the case of reading an instruction manual from a PDF, a web page and the like. A multi-function peripheral has a plurality of functions and includes a display unit displaying information relating to each function, wherein when the information relating to one function is displayed on the display unit, the multi-function peripheral generates and displays an icon in association with the one function, and receive an instruction to execute the one function through the icon.

This application is the national phase under 35 U.S.C. §371 of PCT International Application No. PCT/JP2013/081725 which has an International filing date of Nov. 26, 2013 and designated the United States of America.

### BACKGROUND 1. Technical Field

The present invention relates to an electric equipment which has a plurality of functions and includes a display unit displaying information relating to each function.

2. Description of Related Art

In recent years, an MFP has been multi-functionalized and the contents of an instruction manual therefor has become large. Therefore, it is often possible to read the instruction manual from a PDF or a web page by providing the instruction manual as electronic data.

Further, Japanese Patent Application Laid-open No. 2006-260249 discloses an electronic image handling device capable of editing electronic data of the instruction manual so as to have user-friendliness according to a usage, a level of proficiency, and an experience degree of each user.

### SUMMARY

Meanwhile, as described above, in the case that the instruction manual can be read from the PDF, the web page, or the like, when a user wants to reuse a prescribed function, which was used by consulting an operation method, some other day, if the user forgets the operation method, he/she needs to examine a huge amount of the instruction manual again, which causes inconvenience to the user.

However, the electronic image handling device disclosed in Japanese Patent Application Laid-open No. 2006-260249 only customizes the instruction manual, and therefore may not solve the above problem.

In consideration of the above-mentioned circumstances, it is an object of the present invention to provide an electric equipment which has a plurality of functions and includes a display unit displaying information relating to each function, in which when information relating to one function is displayed, an icon is generated and displayed in association with the one function, and an instruction to execute the one function through the icon is received, such that there is no need to examine the information many times at the time of using the same function, and it is possible to simply execute the function only by appropriately operating the generated icon.

According to one aspect of the present invention, there is provided an electric equipment which has a plurality of functions and includes a display unit displaying information relating to each function, including: a generation instruction receiving means configured to, when the information relating to one function is displayed, receive an instruction to generate and display an icon; a storage unit configured to store the one function in association with the icon; and an execution instruction receiving means configured to receive an instruction to execute the one function through the icon.

In the electric equipment according to the present invention, the storage unit may store an electronic instruction manual, and the information relating to the one function may be a description relating to a prescribed function included in the electronic instruction manual.

In the electric equipment according to the present invention, when the generation instruction receiving means receives the instruction to generate and display the icon, characters of a description image which is being displayed on the display unit may be recognized, and the one function may be specified.

In the electric equipment according to the present invention, the storage unit may store other functions in association with the icon, and the execution instruction receiving means may be configured to receive an instruction to execute the one function and the other functions through the icon.

In the electric equipment according to the present invention, the one function and the other functions may be functions which are executed in cooperation with each other.

In the electric equipment according to the present invention, the one function and the other functions may be functions which are simultaneously executed.

The electric equipment according to the present invention may include a position receiving means configured to receive a designation of a position at which the icon is to be displayed, wherein the display unit may be configured to display the icon at the position relating to the designation received by the position receiving means.

According to the present invention, in examining the information relating to the function which the user wants to use, the icon receiving the instruction to execute the function is generated, such that there is no need to examine the information many times at the time of using the same function, and it is possible to simply execute the function only by appropriately operating the generated icon.

The above and further objects and features will move fully be apparent from the following detailed description with accompanying drawings.

### BRIEF DESCRIPTION OF THE SEVERAL VIEWS OF THE DRAWINGS

FIG. 1 is a functional block diagram illustrating a configuration of main parts of a multi-function peripheral according to an embodiment of the present invention.

FIG. 2 is a functional block diagram illustrating a configuration of main parts of a control unit, in the multi-function peripheral according to the embodiment of the present invention.

FIG. 3 is a flow chart describing a generation and a display of an icon, in the multi-function peripheral according to the embodiment of the present invention.

FIG. 4 is an exemplified diagram illustrating an example of an electronic instruction manual displayed on a display unit, in the multi-function peripheral according to the embodiment of the present invention.

FIG. 5 is an exemplified diagram illustrating an example of an icon generating screen displayed on a display screen of the display unit, in the multi-function peripheral according to the embodiment of the present invention.

FIG. 6 is a view for describing processing to receive a selection of functions to be added, in the multi-function peripheral according to the embodiment of the present invention.

FIG. 7 is an exemplified diagram illustrating an example of a specific icon displayed on the display screen of the display unit, in the multi-function peripheral according to the embodiment of the present invention.

FIG. 8 is an exemplified diagram illustrating another example of a specific icon displayed on the display screen of the display unit, in the multi-function peripheral according to the embodiment of the present invention.

FIG. 9 is an exemplified diagram illustrating another example of a specific icon displayed on the display screen of the display unit, in the multi-function peripheral according to the embodiment of the present invention.

FIG. 10 is an exemplified diagram illustrating another example of a specific icon displayed on the display screen of the display unit, in the multi-function peripheral according to the embodiment of the present invention.

FIG. 11 is an exemplified diagram illustrating another example of a specific icon displayed on the display screen of the display unit, in the multi-function peripheral according to the embodiment of the present invention.

FIG. 12 is an exemplified diagram illustrating another example of a specific icon displayed on the display screen of the display unit, in the multi-function peripheral according to the embodiment of the present invention.

### DETAILED DESCRIPTION

Hereinafter, a case in which an electric equipment according to embodiments of the present invention is applied a multi-function peripheral having a function of a so-called touch panel will be described in detail, by way of an example, with reference to the accompanying drawings.

### Embodiment 1

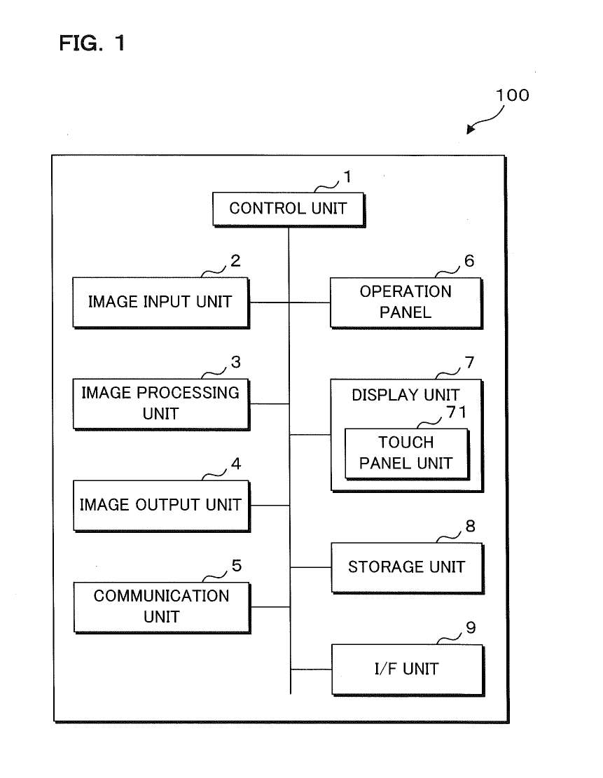

FIG. 1 is a functional block diagram illustrating a configuration of main parts of a multi-function peripheral 100 according to an embodiment of the present invention. The multi-function peripheral 100 according to the embodiment of the present invention includes hardware such as a control unit 1, an image input unit 2, an image processing unit 3, an image output unit 4, a communication unit 5, an operation panel 6, a display unit 7, a storage unit 8 and an I/F unit 9, and forms a digital multi-function peripheral as s whole.

The image input unit 2 optically reads image data of a manuscript. Further, the image input unit 2 includes a light source irradiating a manuscript for reading with light, for example, an optical unit having an image sensor such as a charge coupled device (CCD). Further, the image input unit 2 forms an optical image reflected from the manuscript set at a prescribed read position on the image sensor to output analog electrical signal of RGB (red (R), green (G) and blue (B)). The analog electrical signal output from the image input unit 2 is input to the image processing unit 3.

The image processing unit 3 generates digital type image data based on the analog electrical signal input through the image input unit 2, reads image data stored in the storage unit 8, and performs processing depending on a type of each image, and then generates the image data for outputting.

The image output unit 4 forms an image on a sheet such as recording paper and an OHP film based on the image data output from the image processing unit 3, and outputs the formed image. Therefore, the image output unit 4 includes a photoreceptor drum, a charger for charging the photoreceptor drum to a prescribed potential, a laser writing device wihc emits a laser beam depending on the image data received from an outside to generate an electrostatic latent image on the photosensitive drum, a developer which supplies a toner to the electrostatic latent image formed on a surface of the photoreceptor drum to to develope an image, a transfer unit (not illustrated) which transfers a toner image formed on the surface of the photoreceptor drum onto paper, and the like, and forms an image desired by a user on the sheet by an electro-photographic system. Further, in addition to forming the image by the electro-photographic system using the laser writing device, the image may be formed by an inkjet system, a thermal transfer system, a sublimation system or the like.

The communication unit 5 includes a network card, a modem, and the like which transmits image data processed by the image processing unit 3 to the outside and transmits, for example, the image data attached to an e-mail to a set designation.

The operation panel 6 includes functional buttons, such as ‘copy’ and ‘printing’, a numeric pad, an enter key for confirming the received instruction, and the like, which are related to important functions of the multi-function peripheral 100.

The storage unit 8 includes, for example, a non-volatile storage medium, such as a flash memory, an EEPROM, an HDD, a magnetic resistance memory (MRAM), a ferroelectric RAM (FeRAM), an OUM and the like. The storage unit 8 stores, for example, the image data of the manuscript read by the image input unit 2, a parameter value relating to the image formation in the image output unit 4 and the like.

Further, the storage unit 8 stores an instruction manual for the multi-function peripheral 100 as a data file. The display unit 7 displays contents of the instruction manual (hereinafter, referred to as an electronic instruction manual) based on the data file of the instruction manual.

The display unit 7 includes, for example, an LCD, an electroluminescent (EL) panel, or the like and displays an image to be output (printed) to prescribed recording paper through the image output unit 4. Further, the display unit 7 displays information to be notified to the user, such as a condition of the multi-function peripheral 100, a job processing condition, an image of a manuscript read by the image input unit 2, and a confirmation of an operation content of the operation panel 6 and the like.

Further, the display unit 7 displays the electronic instruction manual, and a function icon to be described below thereon.

Further, the display unit 7 is provided with a touch panel unit 71 on a front side of a display screen on which the image is displayed. The touch panel unit 71 may detect a prescribed position on the display screen of the display unit 7 by a touch operation of a user's finger tip. The touch panel unit 71 may detect a change in pressure by the touch operation of the user's finger tip, detect an electrical signal by static electricity, and detect coordinates on the display screen of the display unit 7 corresponding to a touched position of the user's finger tip to generate a signal specifying the coordinates. Further, the touch panel unit 71 is not limited thereto, and therefore may have a configuration using a pointing device (for example, stylus pen) and the like.

The I/F unit 9 is connected with, for example, an external server, a PC and the like. When the data file relating to the electronic instruction manual is not stored in the storage unit 8, the control unit 1 may be configured to receive the data file from the external server, the PC, and the like through the I/F unit 9.

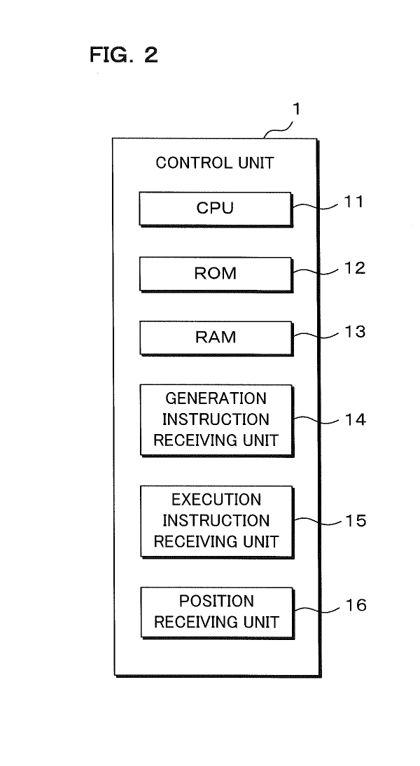

FIG. 2 is a functional block diagram illustrating a configuration of main parts of the control unit 1, in the multi-function peripheral 100 according to the embodiment of the present invention. The control unit 1 includes a CPU 11, a ROM 12, a RAM 13, a generation instruction receiving unit 14, an execution instruction receiving unit 15, and a position receiving unit 16.

The ROM 12 is previously stored with various control programs, fixed data among parameters for operation, and the like, and the RAM 13 temporarily stores data and may read the data irrespective of a storage order, a storage location and the like. Further, the RAM 13 stores, for example, programs read by the ROM 12, various data generated by running the programs, parameters appropriately changed at the time of the running and the like.

The CPU 11 loads and runs control programs previously stored in the ROM 12 onto the RAM 13 to control various types of hardware described above and operate the entire apparatus as the multi-function peripheral 100 of the present invention.

The generation instruction receiving unit 14 receives an instruction to generate and display an icon relating to execution of the prescribed function from the user through an ‘icon generating’ soft key to be described below.

For example, in the case in which the electronic instruction manual is displayd on the display unit 7, when the generation instruction receiving unit 14 receives the instruction, the CPU 11 performs OCR processing on an image which is being displayed, recoginzes characters of the image which is being displayed by a pattern matching method, and specifies a function which is being displayed. Further, the CPU 11 generates the specific icon for receiving the instruction to execute the function corresponding to the image which is being displayed, and displays the generated specific icon on the display unit 7. In this case, the storage unit 8 stores the specific icon in association with the function which is being displayed as the corresponding function (hereinafter, referred to as the corresponding function).

Further, the present invention is not limited thereto, and therefore the prescribed functions may be previously associated with each page of the electronic instruction manual.

The execution instruction receiving unit 15 receives an instruction to execute the corresponding function through the specific icon. For example, when the user's finger tip performs a touch operation on the specific icon or double-clicks the specific icon using a mouse (not illustrated), the touch panel unit 71 detects coordinates on the display screen of the display unit 7, corresponding to the position of the specific icon, and transmits the signal specifying the coordinates to the control unit 1. In this case, the execution instruction receiving unit 15 receives the instruction to execute the corresponding function relating to the specific icon.

The position receiving unit 16 receives the designation of a position in which the generated specific icon is to be displayed from the user. When the generation instruction receiving unit 14 receives the instruction to generate and display the icon relating to the execution of the prescribed function from the user, and the specific icon is generated, the user appropriately operates the operation panel 6 to designate the position in which the generated specific icon is to be displayed, such that the position receiving unit 16 receives the designation of the position. As the position in which the generated specific icon is to be displayed, for example, there is a so-called home screen, and a prescribed directory.

Hereinafter, the generation and the display of the specific icon, in the multi-function peripheral 100 according to the embodiment of the present invention will be described in detail.

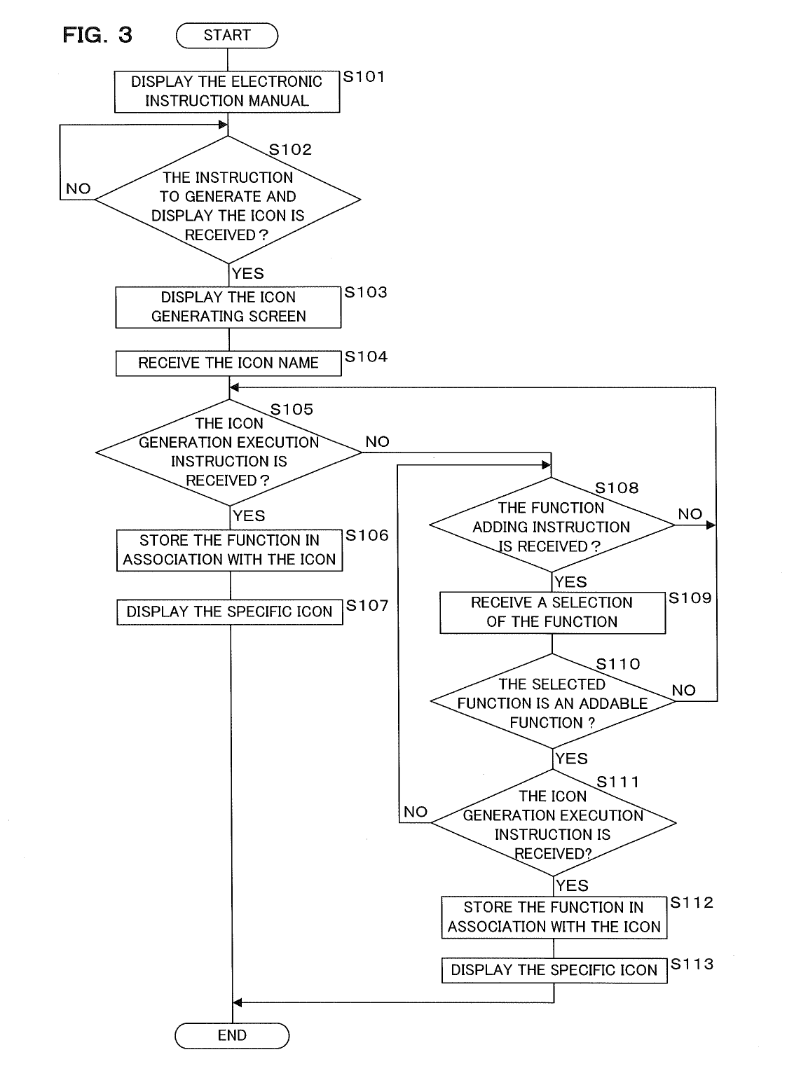

FIG. 3 is a flow chart describing the generation and the display of the icon, in the multi-function peripheral 100 according to the embodiment of the present invention.

The user appropriately operates the operation panel 6 to display the electronic instruction manual on the display unit 7. In this case, the CPU 11 receives an instruction to display the electronic instruction manual through the operation panel 6.

The CPU 11 reads the data file from the storage unit 8 according to the received instruction and displays the electronic instruction manual on the display unit 7 based on the instruction (step S101).

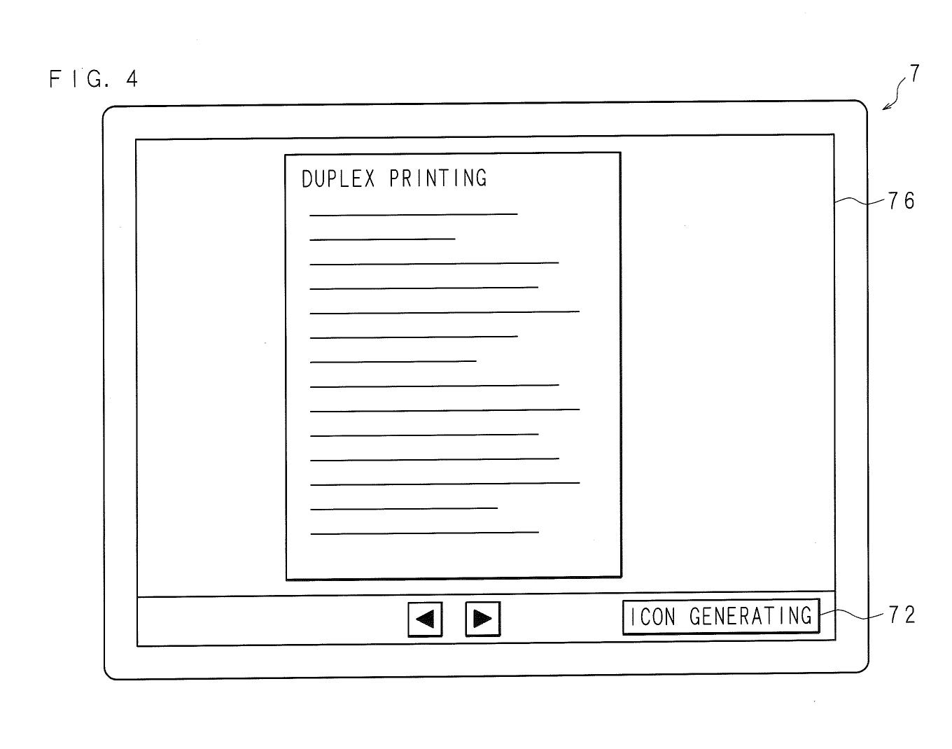

FIG. 4 is an exemplified diagram illustrating an example of the electronic instruction manual displayed on the display unit 7, in the multi-function peripheral 100 according to the embodiment of the present invention. In this case, as illustrated in FIG. 4, the display unit 7 is provided with soft keys on a lower portion of a display screen 76 thereof for receiving the instruction to display other pages, and the user appropriately operates the soft keys to search for the description of the desired function.

Further, the display screen 76 is provided with an ‘icon generating’ soft key 72 on a lower right side thereof, and the generation instruction receiving unit 14 receives the instruction to generate and display the icon relating to the execution of the prescribed function from the user through the ‘icon generating’ soft key 72.

In this case, the generation instruction receiving unit 14 monitors the ‘icon generating’ soft key 72, in other words, determines whether the instruction to generate and display the icon is received from the user based on the signal transmitted from the touch panel unit 71 (step S102).

If it is determined that the instruction to generate and display the icon is not received from the user (step S102: NO), the generation instruction receiving unit 14 repeats the determination up to receiving the instruction. In this case, the electronic instruction manual is continuously displayed on the display screen 76 of the display unit 7.

If it is determined by the generation instruction receiving unit 14 that the instruction to generate and display the icon is received from the user (step S102: YES), the CPU 11 displays the icon generating screen for receiving the setting relating to the icon generation on the display screen 76 (step S103).

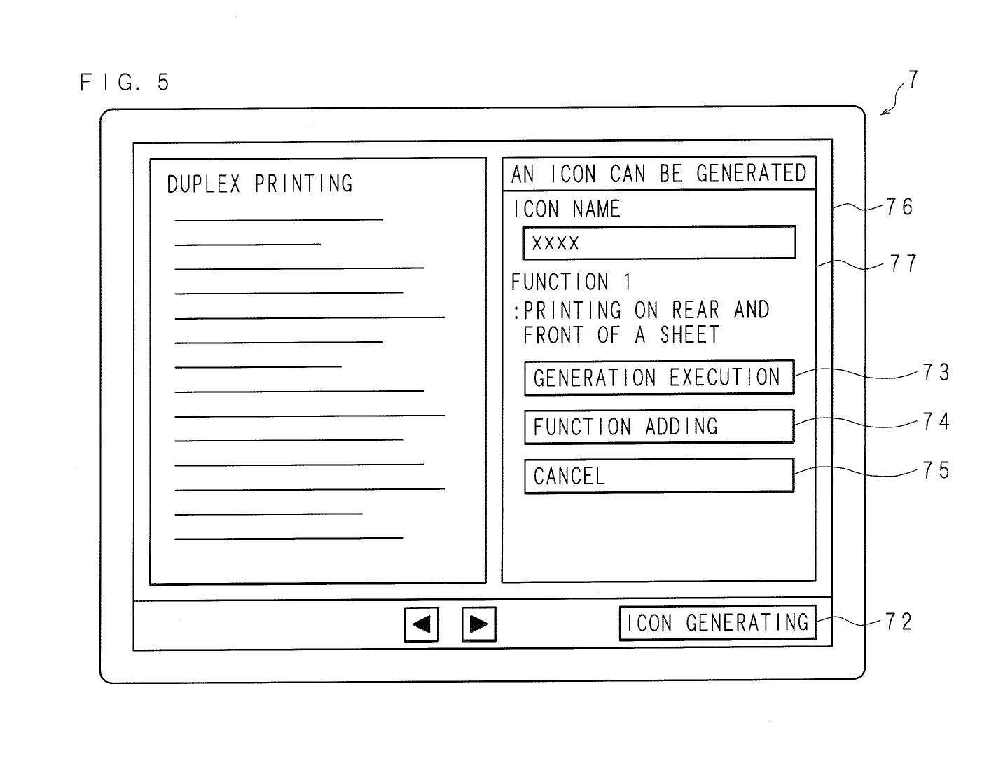

FIG. 5 is an exemplified diagram illustrating an example of an icon generating screen 77 displayed on the display screen 76 of the display unit 7, in the multi-function peripheral 100 according to the embodiment of the present invention.

As illustrated in FIG. 5, the icon generating screen 77 displays a text box for receiving an input of an icon (specific icon) name to be generated and a text box for describing a function corresponding to the icon to be generated (corresponding function).

In more detail, currently, the display screen 76 displays a description portion for a duplex printing function of the electronic instruction manual. Further, as described above, the function which is being displayed is specified by the OCR processing and the pattern matching method, and a text for describing the specified function is displayed on the icon generating screen 77.

The display screen 76 displays the description for the ‘duplex printing’ function. Therefore, in an example illustrated in FIG. 5, the icon generating screen 77 displays a text referred to ‘printing on rear and front of a sheet’ describing the ‘duplex printing’ function.

Further, the icon generating screen 77 is provided with a ‘generation execution’ soft key 73 for receiving the instruction (hereinafter, referred to as a generation execution instruction) to execute the icon generation. The user confirms the texts and then appropriately operates the ‘generation execution’ soft key 73 to instruct so as to execute the icon generation.

The case of generating the icon by associating one function with one icon has been described above, but the multi-function peripheral 100 according to the embodiment of the present invention is not limited thereto. It is also possible to generate the icon by associating a plurality of functions with one icon.

As described above, in order to receive the instruction to generate the icon by associating the plurality of functions with one icon (hereinafter, referred to as a function adding instruction), the icon generating screen 77 is provided with a ‘function adding’ soft key 74. The user appropriately may operate the ‘function adding’ soft key 74 to further associate other functions with the icon to be generated. The instruction to execute the plurality of functions associated therewith is received through the icon generated as described above.

Further, the icon generating screen 77 is provided with a ‘cancel’ soft key 75 for receiving an instruction to stop generating the icon.

The user appropriately operates the operation panel 6 to write an icon name (for example, ‘XXXX’) to be generated in the text box of the icon generating screen 77. Thereby, the CPU 11 receives the icon name through the text box (step S104), and attaches the received icon name to an icon to be generated and displays the same.

Next, the CPU 11 monitors whether the ‘generation execution’ soft key 73 is operated based on the signal transmitted from the touch panel unit 71 to determine whether the icon generation execution instruction is received from the user (step S105).

If it is determined that the icon generation execution instruction is received from the user (step S105: YES), the CPU 11 instructs the storage unit 8 so as to store the function which is being currently displayed on the display screen 76 in association with the icon to be generated.

According to the instruction of the CPU 11, the storage unit 8 stores the function which is being displayed on the display screen 76, that is, in the present embodiment, the ‘duplex printing’ function in association with the icon to be generated (step S106).

Hereinafter, for example, in order to receive the designation of the position in which the icon to be generated will be displayed from the user, the display screen 76 displays a dialog box. The user appropriately operates the operation panel 6 to designate the display position of the icon to be generated. In this case, the position receiving unit 16 receives the designation of the display position of the icon to be generated through the dialog box.

Next, the CPU 11 generates and displays the specific icon based on the designation of the display position of the icon received by the position receiving unit 16 (step S107).

For example, when the displayed specific icon is touched by the user's finger tip, the execution instruction receiving unit 15 receives the instruction to execute the corresponding function through the specific icon, and allows the CPU 11 to execute the ‘duplex printing’ function which is the corresponding function relating to the specific icon.

Meanwhile, in step S105, if it is determined that the icon generation execution instruction is not received from the user (step S105: NO), the CPU 11 monitors whether the ‘function adding’ soft key 74 is operated based on the signal transmitted from the touch panel unit 71 to further determine whether the function adding instruction is received from the user (step S108).

If it is determined that the function adding instruction is not received from the user (step S108: NO), the CPU 11 determines whether the ‘cancel’ soft key 75 is operated based on the signal transmitted from the touch panel unit 71, and if it is determined that the soft key is not operated, the processing returns back to step S105.

Further, if it is determined that the function adding instruction is received from the user (step S108: YES), the CPU 11 receives a selection of the function to be added by the same method as the processing in step S102 (step S109).

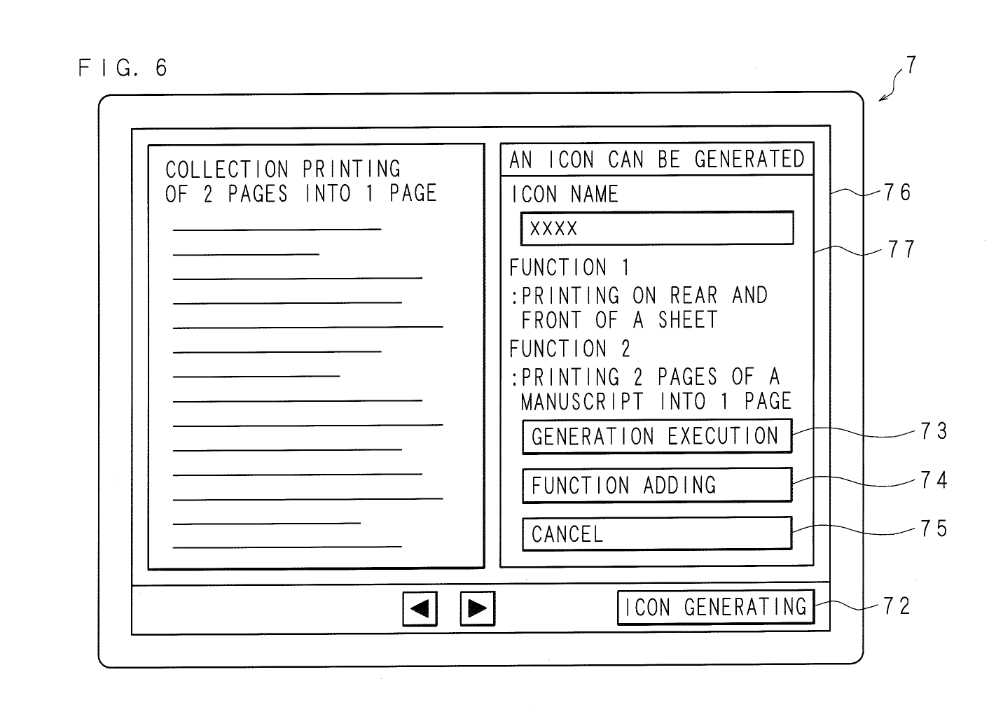

Hereinafter the processing to receive the selection of functions to be added will be described in detail. FIG. 6 is a view for describing the processing to receive the selection of functions to be added, in the multi-function peripheral 100 according to the embodiment of the present invention. For convenience of explanation, it is assumed that the user wants to add a ‘collection printing function of 2 pages into 1 page.’

The user appropriately operates the soft key displayed on the lower portion of the display screen 76 of the display unit 7 on which the electronic instruction manual is displayed to search for the desired function from the electronic instruction manual. As illustrated in FIG. 6, when the desired description of the ‘collection printing of 2 pages into 1 page’ function is displayed on the display screen 76, the user appropriately operates the ‘icon generation’ soft key 72. Thereby, the CPU 11 receives the selection of the function to be added from the user.

In this case, as illustrated in FIG. 6, the icon generating screen 77 displays a text of ‘printing 2 pages of a manuscript into 1 page’ for describing the ‘collection printing of 2 pages into 1 page’ function. Thereby, the user may confirms the addition of the function.

As described above, when the selection of the function to be added is received from the user, the CPU 11 determines whether the function relating to the received selection (hereinafter, referred to as a selected function) is the function which may be added (step S110).

The determination is performed based on whether the selected function (function of the collection printing of 2 pages into 1 page) and the function (duplex printing) previously associated with the icon to be generated may be simultaneously executed, or may be executed in cooperation with each other.

As the function which may be added, there are, for example, the duplex printing and the collection printing, external transmission and copying of the read image data, storing and copying of the read image data into a USB memory, etc. Further, as the function which may not be added, there are, for example, color copying, monochrome copying and the like.

If it is determined that the selected function is not the function which may be added (step S110: No), the CPU 11 returns the processing to step S105.

Meanwhile, if it is determined that the selected function is the function which may be added (step S110: YES), the CPU 11 monitors whether the ‘generation execution’ soft key 73 is operated based on the signal transmitted from the touch panel unit 71 to further determine whether the icon generation execution instruction is received from the user (step S111).

If it is determined that the icon generation execution instruction is not received from the user (step S111: NO), the CPU 11 returns the processing to step S108.

If it is determined that the icon generation execution instruction is received from the user (step S111: YES), the CPU 11 instructs the storage unit 8 so as to store the function (collection function of 2 pages into 1 page) which is being currently displayed on the display screen 76, in other words, the function added this time in association with the icon to be generated.

According to the instruction of the CPU 11, the storage unit 8 stores the function of ‘collection printing of 2 pages into 1 page’ which is being displayed on the display screen 76 in association with the icon to be generated, in addition to the function of the ‘duplex printing’ (step S112).

Next, as described above, the position receiving unit 16 receives the designation of the display position of the icon to be generated from the user. The CPU 11 generates and displays the specific icon based on the designation of the icon display position received by the position receiving unit 16 (step S113).

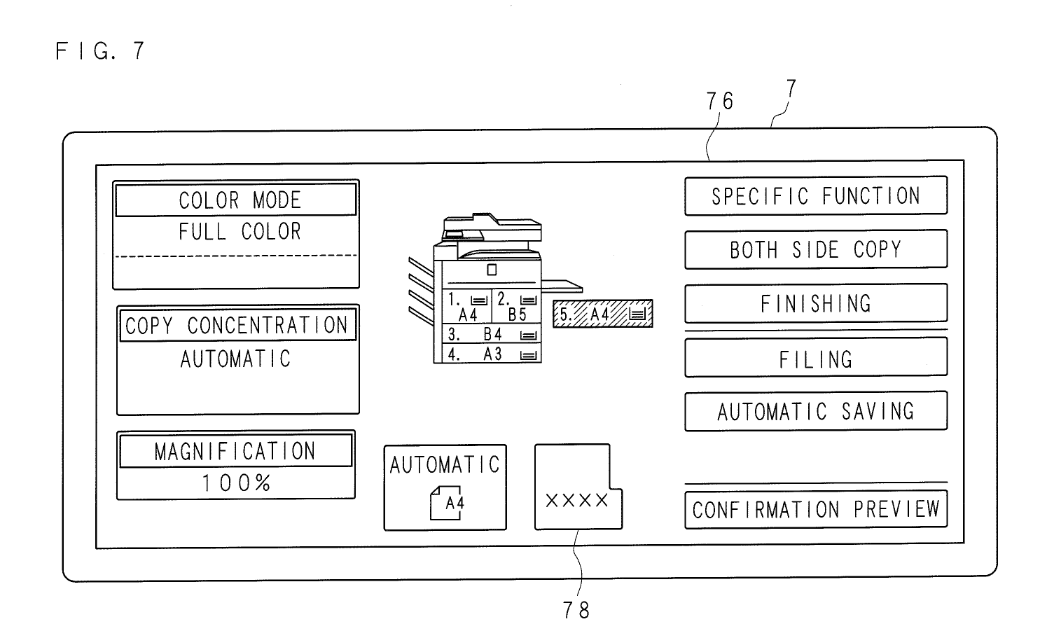

FIG. 7 is an exemplified diagram illustrating an example of the specific icon displayed on the display screen 76 of the display unit 7, in the multi-function peripheral 100 according to the embodiment of the present invention. For convenience of explanation, it is assumed that the position receiving unit 16 receives the so-called home screen as the display position of the specific icon.

As illustrated in FIG. 7, the home screen relating to the instruction received by the position receiving unit 16 displays a specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

### Embodiment 2

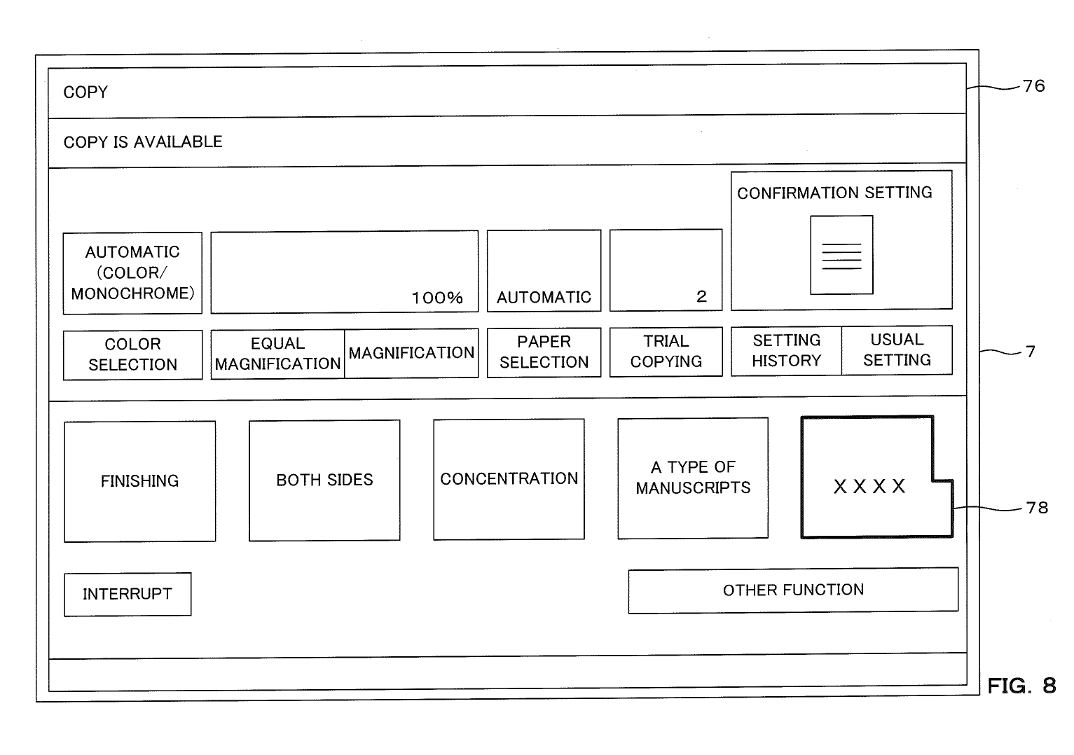

FIG. 8 is an exemplified diagram illustrating another example of the specific icon displayed on the display screen 76 of the display unit 7, in the multi-function peripheral 100 according to the embodiment of the present invention. In this example, it is assumed that the position receiving unit 16 receives a basic screen of a copying function as a display position of the specific icon 78. In the basic screen of the copying function, soft keys of functions (color selection, equal magnification, magnification, paper selection, trial copying, etc.) which are frequently used at the time of setting various functions relating to the copying is displayed, which may not be changed in the setting. Among the functions (other functions) which are used at the time of setting various functions relating to the copying other than the above-described soft key, the icon (shortcut) of the function which is relatively more frequently used is also displayed. Icons such as finishing, both sides, concentration, and a type of manuscripts which are illustrated in FIG. 8 are only an example, and therefore it is possible to change the settings according to the user application. For example, the specific icon 78 is displayed together with these icons.

As illustrated in FIG. 8, the basic screen of the copying function relating to the instruction received by the position receiving unit 16 displays the specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

### Embodiment 3

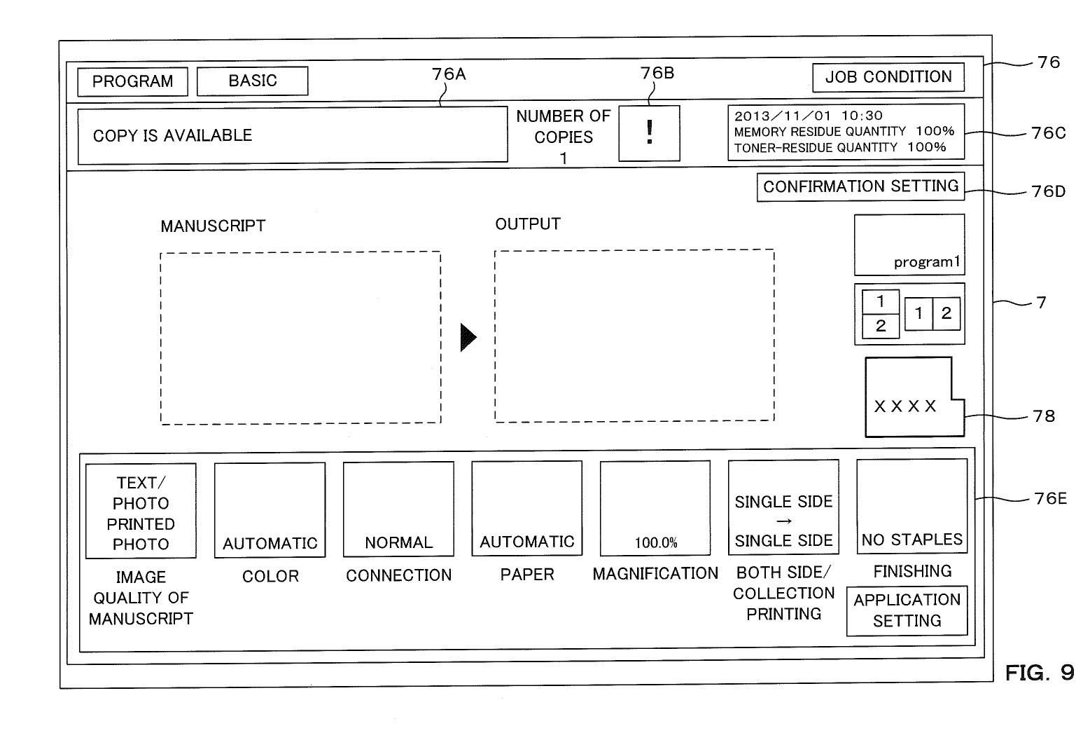

FIG. 9 is an exemplified diagram illustrating another example of the specific icon displayed on the display screen 76 of the display unit 7, in the multi-function peripheral 100 according to the embodiment of the present invention. In this example, it is assumed that the position receiving unit 16 receives the basic screen of the copying function as the display position of the specific icon 78. The basic screen of the copying function displays a message display area 76A, an icon display area 76B, a date/memory residue quantity/toner-residue quantity display area 76C, a setting confirmation soft key 76D, and a function display area 76E.

The message display area 76A displays messages such as a condition of multi-function peripheral 100 and an operation order. When displaying of the icon representing the condition of multi-function peripheral 100 is required, the icon display area 76B displays the icon representing, for example, a job condition, an alarm, a connection condition of the USB memory or the like. The date/memory residue quantity/toner-residue quantity display area 76C displays current date and time, the memory residue quantity, and the toner residue quantity of each color. Through the setting confirmation soft key 76D, a function which is currently set in each mode may be confirmed. Further, the function display area 76E displays a function key which is frequently used at the time of setting various functions relating to each mode, and it is possible to change the settings according to the user application.

Further, the basic screen of the copying function displays a preview image in the case of being output by the collection printing when enlargement or reduction processing, etc. is executed for the read manuscript image. Further, when the setting of the read manuscript is changed (color change, concentration change, magnification change, change in the number of collection pages in the collection printing, etc.), an image to which the change in the setting is reflected is displayed together with the read manuscript image. For example, the specific icon 78 is displayed together with the preview image.

As illustrated in FIG. 9, the basic screen of the copying function relating to the instruction received by the position receiving unit 16 displays the specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

### Embodiment 4

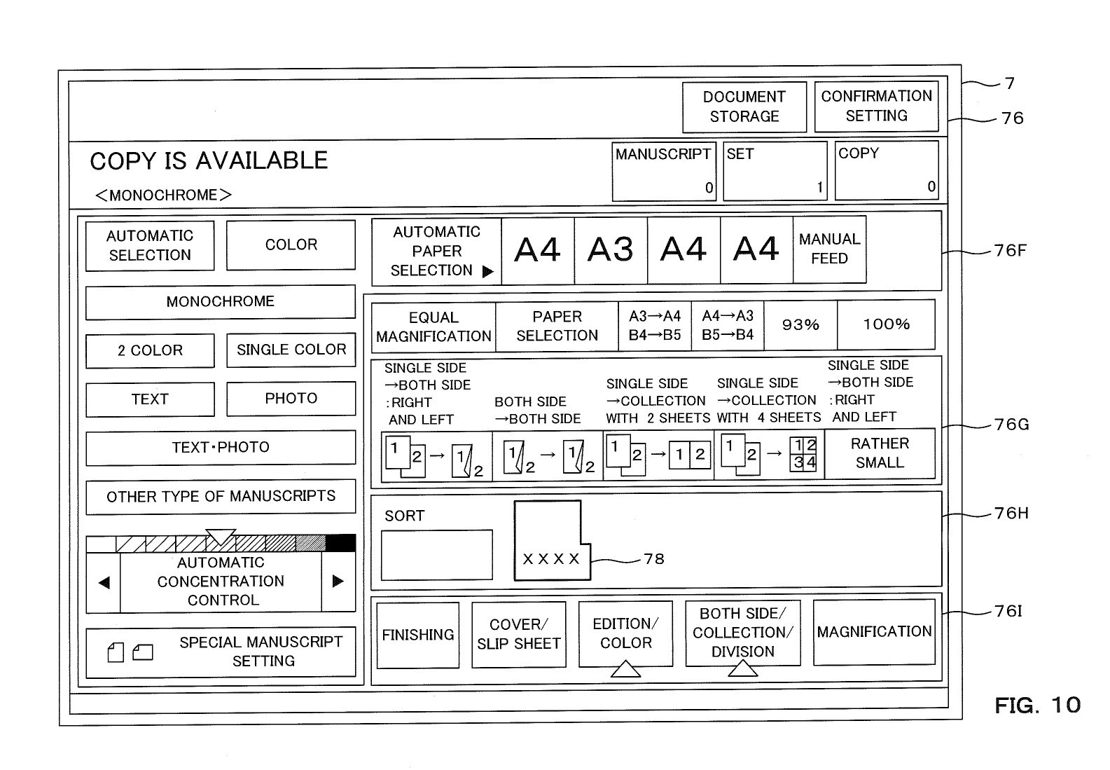

FIG. 10 is an exemplified diagram illustrating another example of the specific icon displayed on the display screen 76 of the display unit 7, in the multi-function peripheral 100 according to the embodiment of the present invention. In this example, it is assumed that the position receiving unit 16 receives the basic screen of the copying function as the display position of the specific icon 78. The basic screen of the copying function displays an area 76F, an area 76G, an area 76H, and an area 76I.

The area 76F displays various items (color mode, the number of copies, paper feeding tray, a type of manuscripts, copying concentration, special manuscript setting, manuscript setting direction, cover/slip sheet, edition/color, both sides/collection/division, initial value of finishing, etc.) of a basic copying setting tab, and may be set/changed for each function. The area 76G displays up to six of the functions which are frequently used and registered as a registration function key, and an area 76H registers setting and operation conditions, which are frequently used, as an initial value and displays the icons (shortcut) corresponding thereto. The user appropriately operates the icons to call the functions, for example, the specific icon 78 is displayed together with these icons. The area 76I displays a tab for receiving various kinds of setting relating to the copying from the user.

As illustrated in FIG. 10, the basic screen of the copying function relating to the instruction received by the position receiving unit 16 displays the specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

### Embodiment 5

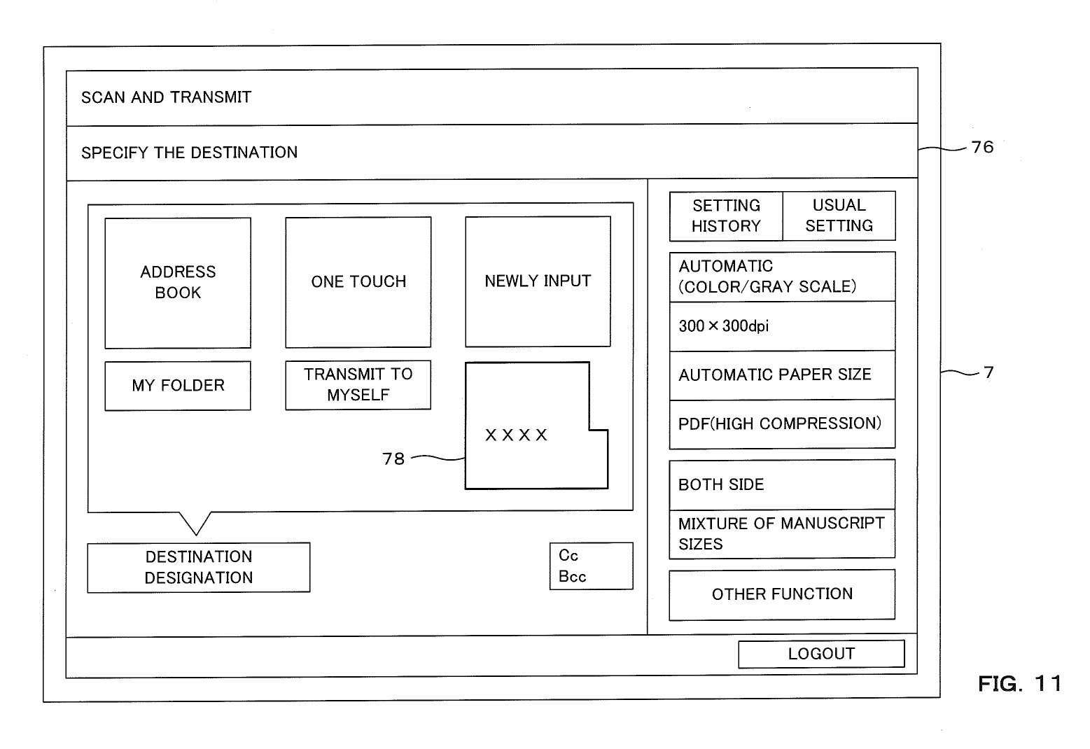

FIG. 11 is an exemplified diagram illustrating another example of the specific icon displayed on the display screen 76 of the display unit 7, in the multi-function peripheral 100 according to the embodiment of the present invention. In this example, it is assumed that the position receiving unit 16 receives a basic screen of a facsimile function as the display position of the specific icon 78. The basic screen of the facsimile function displays a ‘one touch’ icon in which a destination of facsimile communication which is frequently used is registered in advance, a ‘newly input’ icon for newly inputting a destination and the like. For example, the specific icon 78 is displayed together with these icons.

As illustrated in FIG. 11, the basic screen of the facsimile function relating to the instruction received by the position receiving unit 16 displays the specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

### Embodiment 6

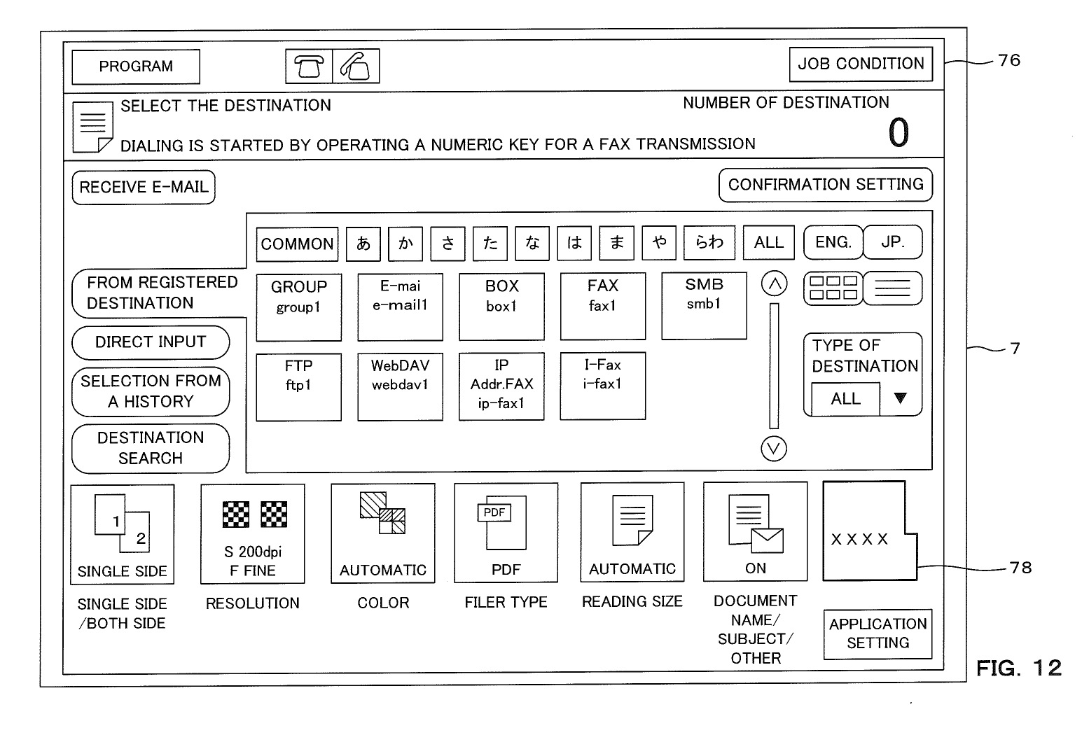

FIG. 12 is an exemplified diagram illustrating another example of the specific icon displayed on the display screen 76 of the display unit 7, in the multi-function peripheral 100 according to the embodiment of the present invention. In this example, it is assumed that the position receiving unit 16 receives a selection screen of a destination for the facsimile function as the display position of the specific icon 78. The selection screen of the destination is provided with icons of ‘from registered destination’, ‘direct input’, ‘selection from a history’, and ‘destination search’ for receiving the selection of the destination. In addition thereto, the selection screen of the destination displays icons of ‘single side/both sides’ receiving a selection of an object to be scanned, ‘resolution’ receiving a resolution of scanning, ‘filer type’ receiving a selection of the file type preserving the scanned data, ‘reading size’ receiving size setting of the manuscript to be scanned and the like. For example, the specific icon 78 is displayed together with these icons.

As illustrated in FIG. 12, the selection screen of the destination for the facsimile function relating to the instruction received by the position receiving unit 16 displays the specific icon 78 to which the name ‘XXXX’ received from the user in step S104 is attached. In this case, for example, when the specific icon 78 is touched by the user's fingertip, the execution instruction receiving unit 15 receives the instruction to execute the corresponding function through the specific icon 78, and allows the CPU 11 to execute the ‘duplex printing’ and the ‘collection printing of 2 pages into 1 page’ function which is the corresponding function relating to the specific icon 78.

Further, the generation instruction receiving unit 14, the execution instruction receiving unit 15, and the position receiving unit 16 which are described above may be configured as hardware logic, and may be constructed in a software type manner by executing a prescribed program on the CPU 11.

In the above description, the case of associating one or a plurality of functions with one icon and receiving the instruction to execute the associated functions through the icon has been described, but the present invention is not limited to the icon, and therefore for example, a soft button, a press bar, and a menu bar may be used.

The present invention provides the electric equipment 100 which has a plurality of functions and includes the display unit 7 which displays information relating to each function, including: a generation instruction receiving means 14 configured to, when the information relating to one function is displayed, receive an instruction to generate and display the icon 78, the storage unit 8 configured to store the one function in association with the icon 78, and an execution instruction receiving means 15 configured to receive the instruction to execute the one function through the icon 78.

According to the present invention, when examining the information relating to the function to which the user wants to use, the icon receiving the instruction to execute the function is generated, such that there is no need to examine the information whenever the user uses the same function, and it is possible to simply execute the function only by approximately operating the icon by the user.

In the electric equipment according to the present invention, the storage unit may store the electronic instruction manual, and the information relating to the one function may be a description relating to a prescribed function included in the electronic instruction manual.

According to the present invention, the electronic instruction manual includes the description relating to the plurality of functions provided in the electric equipment, and the information relating to the one function is the description relating to the prescribed function included in the electronic instruction manual

In the electric equipment according to the present invention, when the generation instruction receiving means receives the instruction to generate and display the icon, characters of a description image which is being displayed on the display unit may be recognized, and the one function may be specified.

According to the present invention, for example, in the case in which the description relating to the prescribed function included in the electronic instruction manual is displayed on the display unit, when the generation instruction receiving means receives the instruction to generate and display the icon, the characters of the description image which is being displayed on the display unit are recognized and the one function is specified.

In the electric equipment according to the present invention, the storage unit 8 may store other functions in association with the icon 78, and the execution instruction receiving means 15 may be configured to receive the instruction to execute the one function and other functions through the icon 78.

According to the present invention, there is no need to examine the information whenever the user uses the same function, and it is possible to simply execute the plurality of functions associated therewith only by approximately operating the icon by the user.

In the electric equipment according to the present invention, the one function and the other functions may be functions which can be executed in cooperation with each other.

According to the present invention, it is possible to concurrently execute the one function and other functions which can be executed in cooperation with each other only by approximately operating the icon by the user.

In the electric equipment according to the present invention, the one function and the other functions may be functions which can be simultaneously executed.

According to the present invention, it is possible to concurrently execute the one function and the other functions which can be simultaneously executed with each other only by approximately operating the icon by the user.

The electric equipment according to the present invention may include a position receiving means 16 configured to receive the designation of the position in which the icon 78 is to be displayed, wherein the display unit 7 may be configured to display the icon 78 at the position relating to the designation received by the position receiving means 16.

According to the embodiment of the present invention, the position receiving means 16 may receive the designation of the user's desired position such as, for example, the display screen of the display unit 7, the prescribed directory, and the like, at the time of generate and display the icon, and display the icon based on the received designation.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An electric equipment which has a plurality of functions and includes a display unit displaying information relating to each function, comprising:
a generation instruction receiving means configured to, when the information relating to one function is displayed, receive an instruction to generate and display an icon;
a storage unit configured to store the one function in association with the icon; and
an execution instruction receiving means configured to receive an instruction to execute the one function through the icon.

2. The electric equipment according to claim 1, wherein the storage unit stores an electronic instruction manual, and
the information relating to the one function is a description relating to a prescribed function included in the electronic instruction manual.

3. The electric equipment according to claim 2, wherein, when the generation instruction receiving means receives the instruction to generate and display the icon, characters of a description image which is being displayed on the display unit are recognized, and the one function is specified.

4. The electric equipment according to claim 1, wherein the storage unit stores other functions in association with the icon, and
the execution instruction receiving means is configured to receive an instruction to execute the one function and the other functions through the icon.

5. The electric equipment according to claim 4, wherein the one function and the other functions are functions which are executed in cooperation with each other.

6. The electric equipment according to claim 4, wherein the one function and the other functions are functions which are simultaneously executed.

7. The electric equipment according to claim 1, comprising:
a position receiving means configured to receive a designation of a position in which the icon is to be displayed,
wherein the display unit is configured to display the icon at the position relating to the designation received by the position receiving means.
